(19) United States
(12) Patent Application Publication
(10) Pub. No.: US 2005/0105108 A1
(43) Pub. Date: May 19, 2005

(54) Print artwork producing method and related device

(75) Inventor: Noritaka Uchibori, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/953,951

(22) Filed: Sep. 30, 2004

(30) Foreign Application Priority Data
Nov. 6, 2003 (JP) 2003-377178
Jul. 14, 2004 (JP) 2004-207176

(51) Int. Cl. G06K 15/02; H04N 1/48; H04N 1/50; H04N 1/60

(52) U.S. Cl. 358/1.9; 358/3.29; 358/3.26; 358/530; 358/518; 358/537; 358/531; 358/505

(57) ABSTRACT

A design is formed by applying processes such as “cutting”, “chipping”, “peeling”, “scorching”, and “compressing” on a surface of a paper sheet with a certain thickness with multi-layered paper fibers. A light is irradiated to a back surface of the paper sheet where the design has been formed, and light emitted from a front surface of the paper sheet is captured to obtain print image data. The obtained print image data is printed from a printer, to produce a print artwork.

### TECHNICAL FIELD

The present invention relates to a print artwork producing method and a related device.

### BACKGROUND ART

Print art is artwork created by duplicating a master plate onto which colors are applied. There is a variety of techniques for producing print art, including wood-block printing, where a design is carved in relief into a series of wooden blocks, ink is applied to the blocks, and the blocks are used to transfer the ink onto paper; copper printing, where designs are made by chipping or eroding the surface of a copper plate; or lithographs, where the artist directly draws a design on a flat stone plate using a greasy crayon, and then the designs are printed by pressing a piece of paper against the stone plate after ink is applied thereto.

Regardless of the technique used, some print artworks are recognized to have extremely high artistic value, and are much sought after by collectors. Prices can reach several million yen for artwork created by a skilled artist whose technical abilities have developed through years of hard study.

Recently, techniques have been proposed for assisting artists in creating print artwork, such as those described in Laid-Open Publication of Japanese Patent Applications No. JP 2002-142095, and JP 05-314254. In these documents, designs are bitmapped with colors on a master plate, modifications are made to the bitmapped data, and the resulting artwork is printed out on paper. However, these techniques merely allow an artist to use electronic means to show artistic expression that can be expressed in conventional techniques such as wood-block printing and copper printing.

### SUMMARY OF THE INVENTION

The object of the present invention is to create print artwork whose aesthetic quality totally differs from that created using conventional techniques, by making use of assets generated when the design of a master plate and the colors applied thereon are processed electronically.

To achieve the above object, the present invention provides a print artwork producing method comprising: obtaining image data defining a design pre-formed on a plate, by irradiating light onto a back surface of the plate and scanning the light transmitted through the plate; digitally processing the obtained image data; and printing the digitally processed image data on a paper medium. Preferably, the plate is a sheet of paper consisting of multi-layered fibers. Also, the pre-formed design may have been formed by at least one of cutting, chipping, peeling, scorching, and compressing.

In a preferred embodiment, the digital processing step of the print artwork producing method may include changing tones of color of the image data obtained in the scanning step. The digital processing step may also include overlaying new image data onto the image data obtained in the obtaining step.

The present invention further provides a print artwork producing device comprising: a storage unit; a light source for irradiating light to a back surface of a plate; an image capturing unit for capturing the light transmitted through the plate and emitted from a front surface of the plate; a generation unit for generating print image data from the light captured by the imaging unit, for storage into the storage unit; and a print image output unit for reading and outputting the print image data stored in the storage unit.

The present invention still further provides a print artwork producing device comprising: a light source for applying light to a back surface of a plate; an image capturing unit for capturing the light transmitted through the plate and emitted from a front surface of the plate; a generation unit for generating print image data from the light captured by the image capturing unit; a storage unit for storing model image data showing a model print artwork, and for storing data of a guide message providing information for correcting processing techniques of the plate, the guide message being stored in correspondence with score data showing deviation of the print image data from the model image data; a computing unit for comparing the print image data to the model image data and obtaining a score showing deviation of the print image data from the model image data; and an output device for reading from the storage unit and outputting a guide message corresponding to the computed score.

The present invention further provides a print artwork generating device comprising: an input unit for inputting print image data received as a result of light being applied to a plate; a storage unit for storing model image data showing a model print artwork, and storing data of a guide message providing information for correcting deviation of the print image data from the model image data, the guide message being stored in correspondence with score data showing the deviation; a computing unit for comparing the print image data input from the input unit to the model image data and obtaining a score showing deviation of the print image data from the model image data; and an output unit for reading from the storage unit and outputting a guide message corresponding to the computed score.

In a preferred embodiment, the above print artwork generating devices further comprise image output means for outputting a model image created based on the model image data and a print image created based on the print image data; image cutting means for cutting an image drawn in a particular area of the model image; and image overwriting means for overwriting the cut image on the print image.

Further, the present invention provides a program product for causing a computer having a light source for applying light to a back surface of a plate; an image capturing unit for capturing the light transmitted through the plate and emitted from a front surface of the plate, so as to obtain print image data; a storage unit for storing model image data showing a model print artwork, and storing data of a guide message providing information for correcting processing techniques of the plate, the guide message being stored in correspondence with score data showing deviation of the print image data from the model image data, to execute a process of generating the print image data from the light captured by the image capturing unit; a process of comparing the generated print image data to the model image data and obtaining a score showing deviation of the print image data from the model image data; and a process of reading from the storage unit and outputting a guide message corresponding to the computed score.

Further, the present invention provides a program product for causing a computer having an input unit for inputting print image data received as a result of light being applied to a plate; a storage unit for storing model image data showing a model print artwork, and storing data of a guide message providing information for correcting deviation of the print image data from the model image data, the guide message being stored in correspondence with score data showing the deviation, to execute a process of comparing the print image data input from the input unit to the model image data and obtaining a score showing deviation between the print image data and the model image data; and a process of reading from the storage unit and outputting a guide message corresponding to the computed score.

According to the present invention, it becomes possible to easily produce a print artwork by utilizing light that penetrates a plate.

### BRIEF DESCRIPTION OF THE DRAWINGS

FIG. 1 is a diagram showing an entire configuration of a print artwork producing system.

FIG. 2 is a diagram showing an example hardware configuration of an image capturing device.

FIG. 3 is a flowchart showing a procedure of paper etching.

FIG. 4 is a diagram for describing a stage of forming a design on a paper sheet, of paper etching.

FIG. 5 is a diagram showing a scanning stage of paper etching.

FIGS. 6A to 6E are sectional views of a paper sheet.

FIG. 7 is a diagram showing a digital processing stage of paper etching.

FIG. 8 is a diagram showing a digital processing stage of paper etching.

FIG. 9 is a diagram showing a printing stage of paper etching.

FIG. 10 is a diagram showing an entire configuration of a print artwork producing system.

FIG. 11 is a diagram showing a data configuration of a guide message database.

FIG. 12 is a flowchart showing an example operation of a second embodiment.

FIG. 13 is a diagram showing a main screen.

FIG. 14 is a diagram showing a main screen displaying a model image.

FIG. 15 is a diagram showing a main screen displaying a print image.

FIG. 16 is a diagram of a main screen displaying a guide message.

FIG. 17 is a diagram showing an entire configuration of a print artwork producing system according to the third embodiment.

### DETAILED DESCRIPTION OF THE PREFERRED EMBODIMENTS

### A. First Embodiment

Description will first be given of a print artwork producing system according to a first embodiment of the present invention. The present embodiment is characterized in that an artist uses the system of the present invention to create an original artwork using a new technique called “paper etching.” Paper etching is a printing technique in which light is irradiated from a backside of a paper sheet on which designs have been formed, and the light transmitted through the paper sheet is scanned by a color scanner to generate a printed artwork.

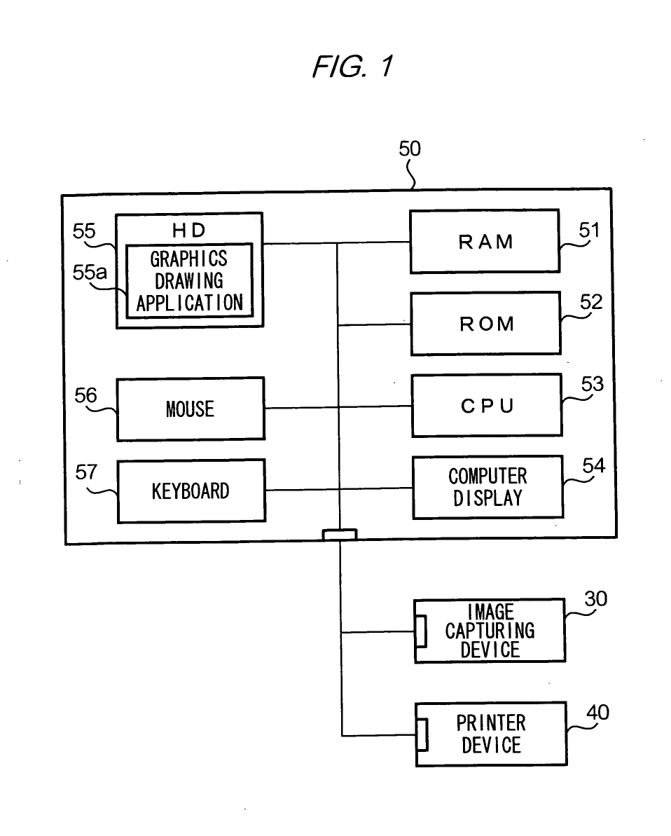

FIG. 1 is a diagram showing an example of an entire configuration of a print artwork producing system according to the present embodiment. As shown in the figure, the system comprises an image data processing device 50, an image capturing device 30, and a printer device 40, each device being connected to the other devices.

Image data processing device 50 comprises a RAM 51, a ROM 52, a CPU 53, a computer display 54, a hard disk (HD) 55, a mouse 56, and a keyboard 57. HD 55 has stored therein an OS (Operating System) software (not shown) and a graphics drawing application 55a such as Illustrator®.

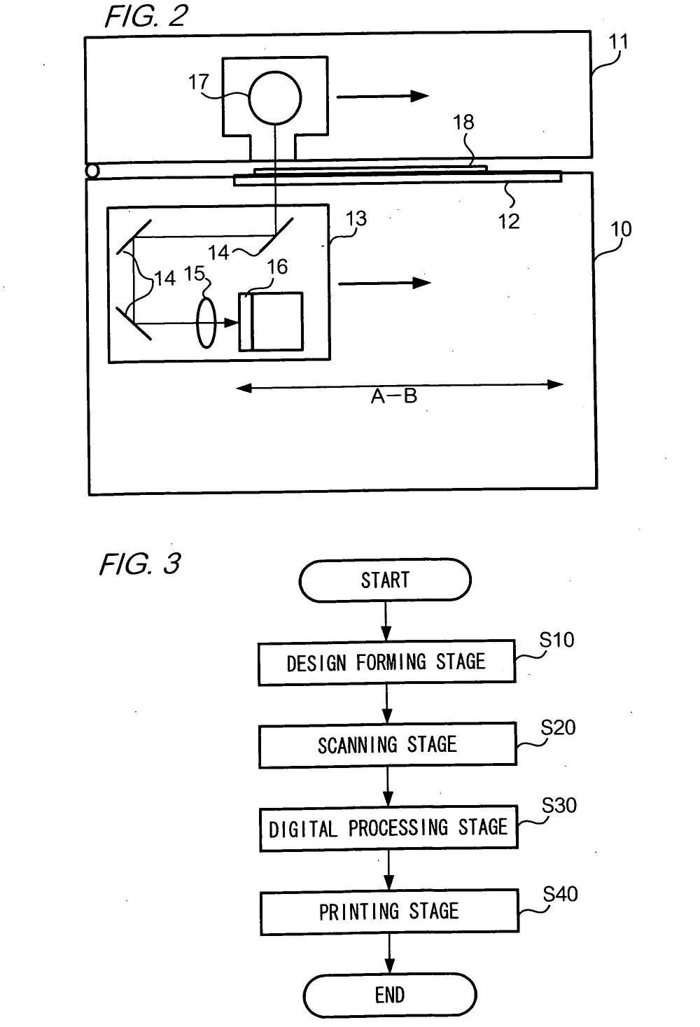

FIG. 2 is a sectional view showing a hardware configuration of image capturing device 30. As shown in the figure, image capturing device 30 comprises a main frame 10 and a main cover 11 on top of main frame 10. Main frame 10 is provided on its upper portion with a transparent plate 12 made of glass. Main frame 10 is further provided therein with a carriage 13 movable in a sub-scanning direction (direction A to B and direction B to A in the figure). Carriage 13 contains a plurality of mirrors 14, a lens 15, and a line sensor 16 such as a CCD (Charge-Coupled Device) line sensor where an array of photosensitive cells is aligned vertically to the moving direction of carriage 13. Main cover 11 is provided with a light source 17 reciprocally movable in synchronization with carriage 13, and powered by a driving device (not shown).

Preferably, image capturing device 30 should be capable of precisely capturing concave sections which have been engraved and convex sections which have been embossed on paper in micron units with a high depth of field. Image capturing device 30 having the above configuration irradiates light toward a back surface of a processed paper sheet 18 placed on transparent plate 12 with the front surface facing downward, and the light transmitted through the processed paper sheet 18 and emitted from the front surface is captured and bitmapped as image data.

Printer device 40 is a well-known inkjet printer which prints an image out of image data output from image data processing device 50. It is preferred that the printer 40 be capable of printing on paper up to the size “B0” (Paper sizes described in this specification are those belonging to international standard ISO 216, but any other standard would be accepted if the size of the paper defined according to the standard is as sufficiently large as that of the ISO standard).

FIG. 3 is a flowchart showing a procedure for producing a print artwork using the paper etching technique. As shown in the figure, the artwork production procedure using the technique includes a stage of forming a design on a paper sheet (Step 10), followed by scanning (Step 20), digital processing (Step 30), and printing (Step 40).

(1) Stage of Forming Design on Paper Sheet

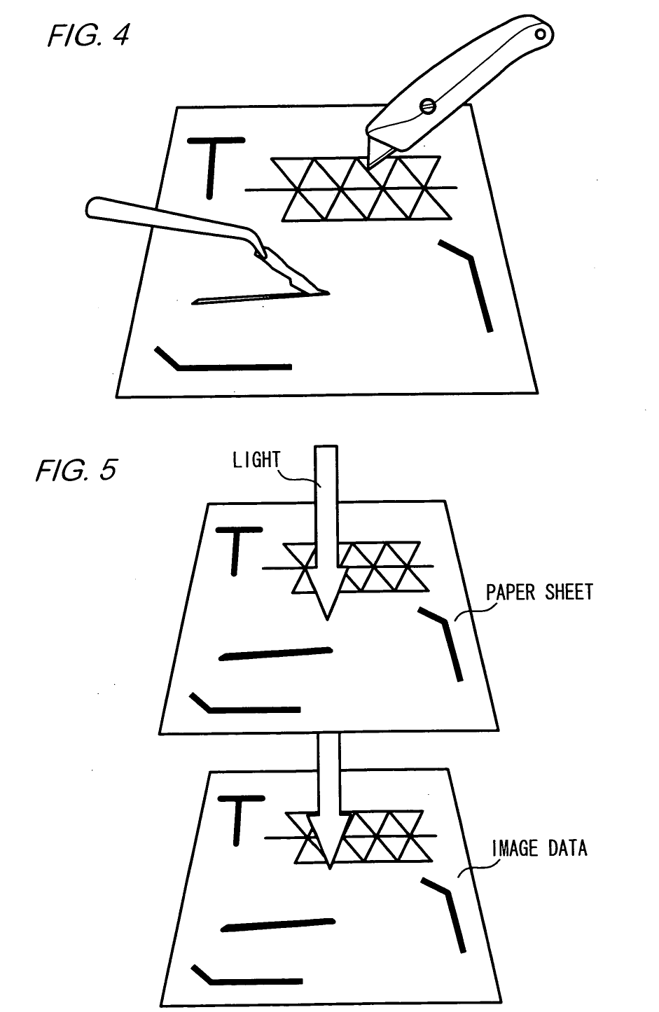

In this stage, a design is formed on a surface of a paper sheet by cutting, chipping, peeling, scorching, and compressing (refer to FIG. 4). A type of paper suited for paper etching is of a certain thickness with multi-layered fibers. It is preferable that the fibers of the paper are tangled in a variety of directions and their length is short (an example of such a type of paper is “ivory Kent”), since using such a type of paper allows an artist flexibility in artistic expression.

In the paper etching technique, a processing technique completely new in the field of printed art, involving peeling, scorching, or compressing is applied to a paper sheet in addition to conventional print techniques of cutting and chipping. When the peeling process is used, a paper sheet is placed on a table, the surface of which has a backlight, and tweezers are used to adjust a thickness of paper in a unit of several fibers while checking an intensity of light transmitted through the paper from the table. The scorching process includes pressing a heated metal iron on a surface of a paper sheet or bringing flame near a paper sheet to brown the surface. When the compressing process is used, lines are incised using a pencil or the like, or an approximately ellipse-shaped recess is produced using a fingertip.

(2) Scanning Stage

When the processing of the paper sheet is finished, image data is obtained by irradiating light to the processed paper sheet using image capturing device 30 (refer to FIG. 5). The obtained image data is transmitted to image data processing device 50 as print image data and stored in HD 55 of the device 50.

An image capturing device used for the paper etching must at least have a function of capturing light that penetrates the paper sheet 18, as shown in FIG. 2, but it is preferred that a function of capturing light reflected from the paper sheet 18 is further provided.

In the scanning, a processed paper sheet 18 is placed on transparent plate 12 of image capturing device 30, light is irradiated from light source 17, and then the transmitted light is captured using line sensor 16. As a result, an image is obtained which is distinctive due to processing techniques used to form designs on paper sheet 18. In a case that image capturing device 30 is provided with a function of capturing reflected light, an image of light reflected from processed paper sheet 18 may also be obtained.

Description will now be given of effects created by the respective five processing techniques. Cutting, peeling, chipping, scorching, and compressing each create different effects depending on an intensity and wavelength of light transmitted through an area where each processing technique is applied.

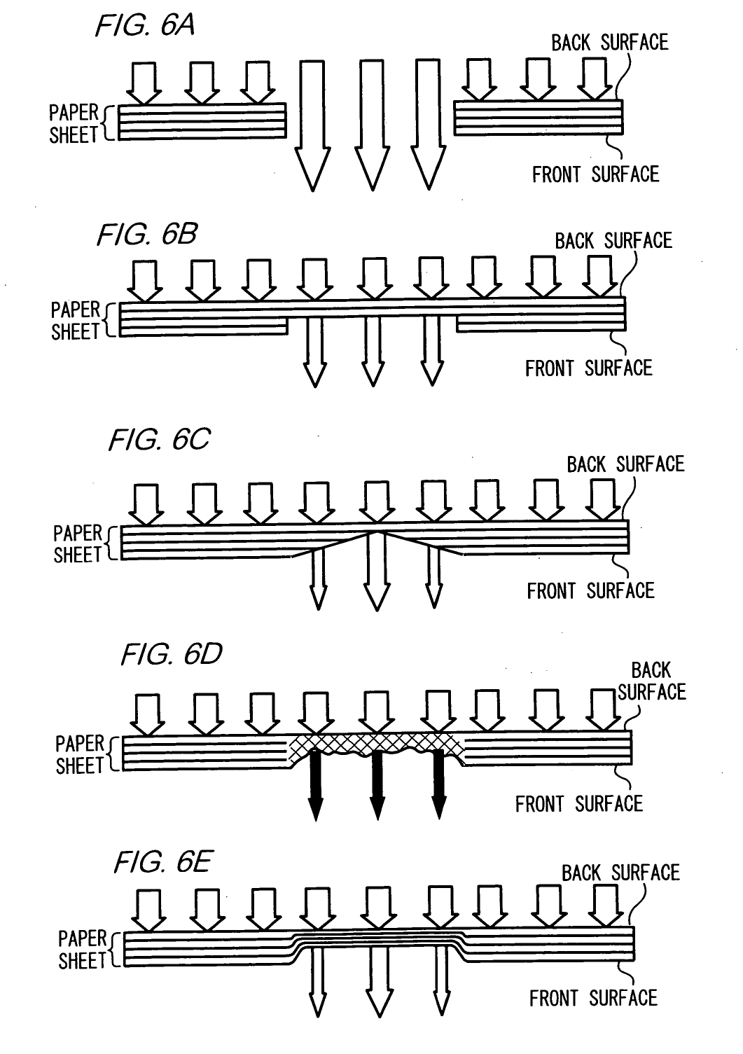

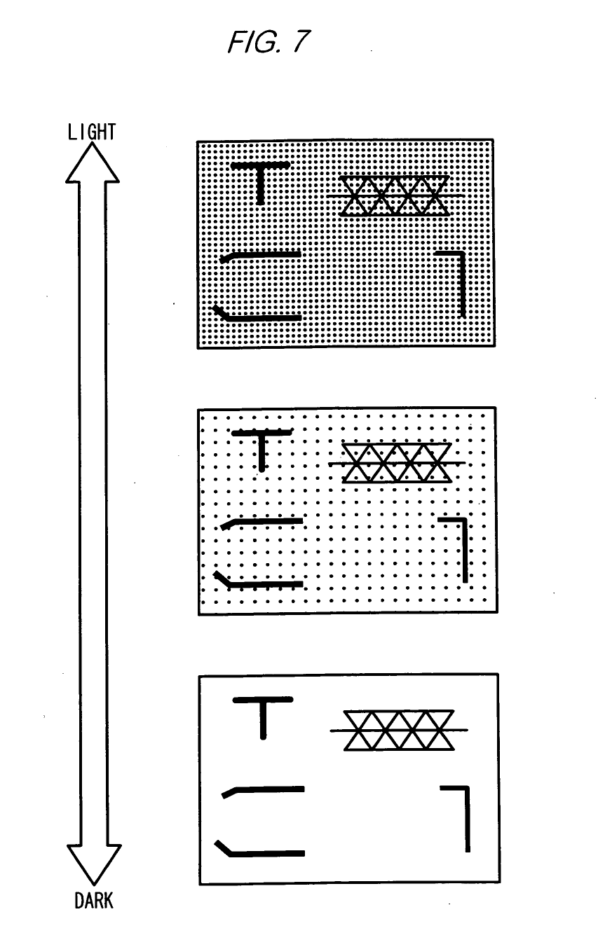

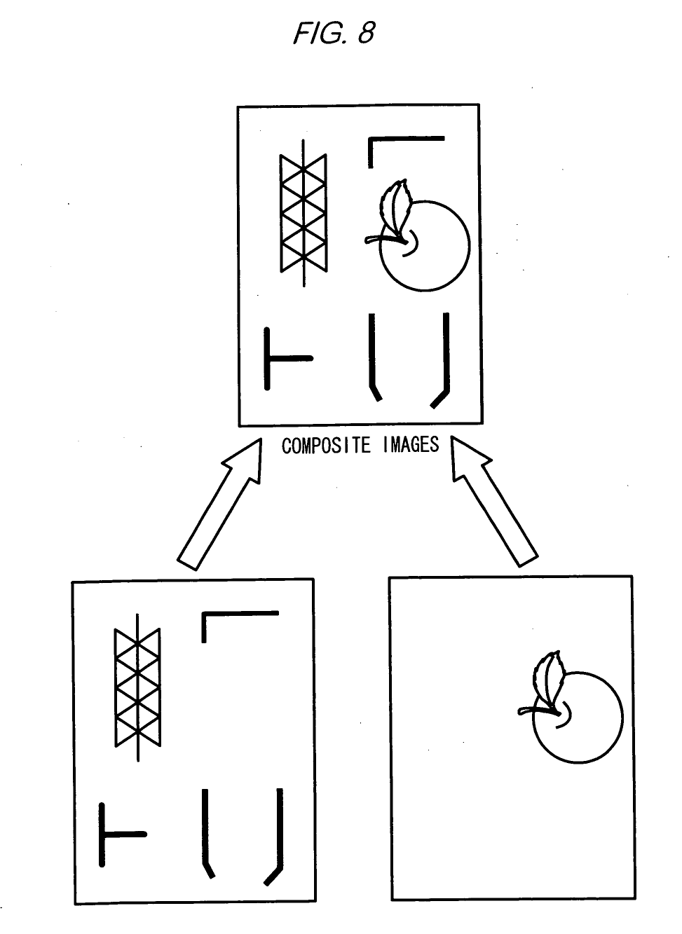

In the case of “cutting”, an area of a paper sheet is cut using a bladed tool used in creating designs; a cross sectional view of a cut area is shown in FIG. 6A. When an image is captured of light irradiated onto a back surface of a paper sheet which has been processed as shown in FIG. 6A, the light irradiated to the cut area is exposed to the sensor without a reduction in its intensity, while the light irradiated onto the surrounding area is completely blocked out. As a result, a cut area of a design can be easily distinguished from the surrounding area.

When the “peeling” technique is used, tweezers or a cutter is used to peel several layers from a surface of a paper sheet to create a design. An example of a thus processed paper sheet is shown in a sectional view of FIG. 6B. The figure shows an example where two layers have been peeled away out of four layers constituting a paper sheet. When an image is captured by irradiating light onto a back surface of a thus processed paper sheet, the intensity of light transmitted through the processed area is reduced uniformly and then exposed to the sensor. As a result, a design is produced having a relatively pale nuance, with the color tone being even.

The chipping technique allows an artist to make a sloping recess in a paper sheet with a carving tool to create a design. A sectional view of a thus processed paper sheet is shown in FIG. 6C. When an image is captured by irradiating light onto a back surface of a thus processed paper sheet, more light is transmitted through a portion near the center of the recessed area, with a received intensity of light being gradually reduced toward the outer edge of the area. Thus, a design can be created with the center of a line being strongly pronounced and gradually fading toward the edge.

In the case of “scorching”, a portion of a paper sheet is scorched by bringing a heated iron or flame near the sheet. As a result, a paper sheet having a section as shown in FIG. 6D is created. When an image is captured by irradiating light to a back surface of a thus processed paper sheet, light transmitted through a portion carbonized by the scorching has a dark color. Thus, a design having a scorched, brown impression can be created using the “scorching” technique.

In the case of “compressing”, a portion of a paper sheet is compressed to create a design having a recessed portion, as in the example shown in FIG. 6E. When an image is captured as a result of irradiating light onto a back surface of a thus processed paper sheet, a large amount of light is transmitted through an almost flat portion near the center of a compressed area, while in a portion proximate to the edge of the compressed area, an amount of light that penetrates the paper sheet decreases gradually. Thus, it is possible to create a design whose boundary with an adjacent portion of the paper has a fuzzy appearance.

(3) Digital Processing Stage

After image data is obtained through the scanning stage, the print image data is read from HD 55 of image data processing device 50, and digital processing is applied to the read image data using the graphics drawing application 55a. In the digital processing stage, the tone of the obtained image is first adjusted by a user. When an image of light transmitted through the paper sheet is captured, uneven color appears on the image as a result of minute differences in the density of fibers forming a paper, since a portion with a low density of fibers easily transmits light, while a portion having a high density of fibers allows penetration by a relatively small intensity of light. The unevenness of color is emphasized when the tone of the color is made brighter and diminished when the tone is made darker. Thus, changing the tone of color results in creation of a background having unique aesthetic properties.

Subsequently, image data with adjusted tones are composited with new image data obtained by capturing an image of light reflected from a paper sheet on which a design is drawn using a paintbrush or the like (refer to FIG. 8). In a case where an image of light reflected from the processed paper sheet 18 has been captured in the scanning stage, a portion of the image data showing the reflected light image may also be composited with the print image data. Thus, image data based on a design of a paper sheet with a surface having an engraved and/or an embossed surface is mixed with image data obtained based on a paper sheet on which color is allocated, to form print image data.

(4) Printing Stage

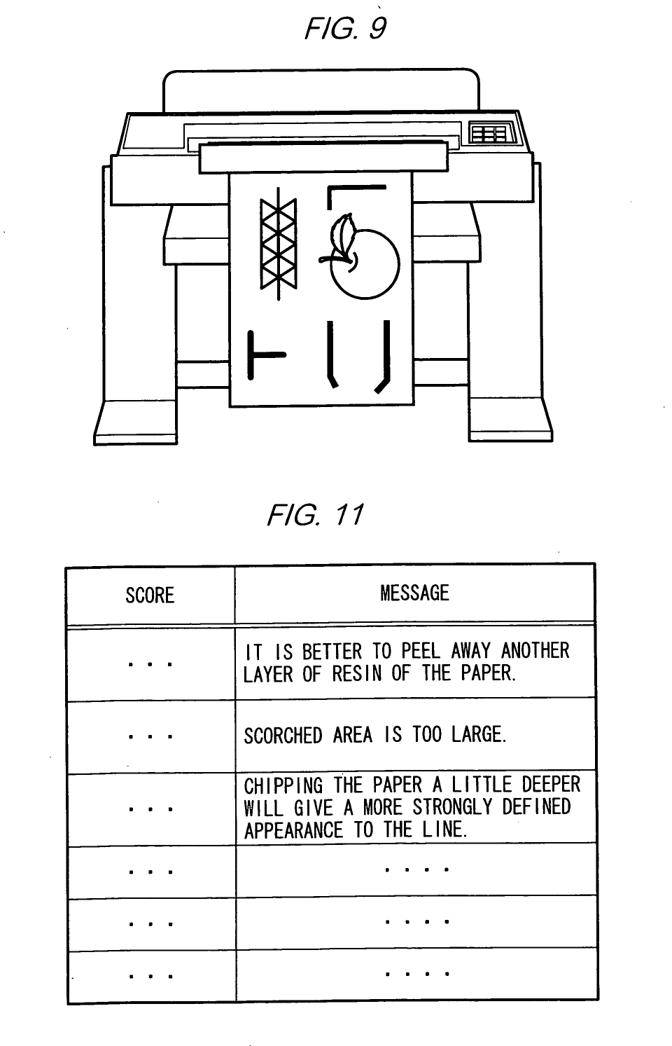

Once the digital processing by image data processing device 50 is completed, the digitally processed print image data is output from printing device 40 (refer to FIG. 9). When the image data is output after enlarging to a size such as “B0”, pronounced edges are maintained, and an artwork having a strong visual impression can be created that differs from an output obtained by printing out image data the same size as that of the processed paper sheet. A suitable type of printer for this printing stage is, for example, a high-specification printer, by which printing uses a total of six colors including Light Cyan and Light Magenta in addition to the four colors of CMYK (Cyan-Magenta-Yellow-blacK), for example, MAXART MC-1000, made by Seiko Epson®. In the actual work, an artist produces a printout that is the closest to a desired image while adjusting a tone of color, a type of a paper medium on which an image is printed out, an output size, and the like.

Using the paper etching technique having the stages described above, it is possible to produce a texture by taking advantage not only of an engraved and/or embossed surface of the processed paper, but also of fibers contained in the paper. Thus, a new type of print art with a unique texture can be produced that totally differs from wood-block printing or copper printing.

Moreover, since a paper sheet is used as a plate, the plate can be processed using a simple instrument such as a cutter or a knife, and a special instrument or hardware such as a paper pressing machine is not required. Therefore, print art can be produced at a low cost. Further, the paper etching technique does not require etchant as in copper printing, thus a print artwork can be produced without adversely affecting the environment.

### B. Second Embodiment

Description will be given of a print artwork producing system according to a second embodiment of the present invention. The second embodiment is characterized in that print image data obtained from a processed paper sheet processed by a learner of a print technique by imitating a model artwork, is compared to image data of the model artwork used as an example (hereinafter, model image data), to compute deviation of the print image data from the model image data. A guide message is then presented to a learner indicating the degree of the computed deviation.

Generally, a degree of skill in producing a print artwork improves dramatically under the guidance of a famous artist, but relatively few people can actually receive such guidance, and many learners develop their skills through self-training. According to the system of the present embodiment, it becomes possible for a learner to easily learn techniques of famous artists without receiving their direct guidance.

The print artwork producing system according to the present invention may be used for acquiring conventional printing techniques such as those used in wood-block printing or copper printing, but is most effective if the system is used for the purpose of acquiring techniques used in paper etching.

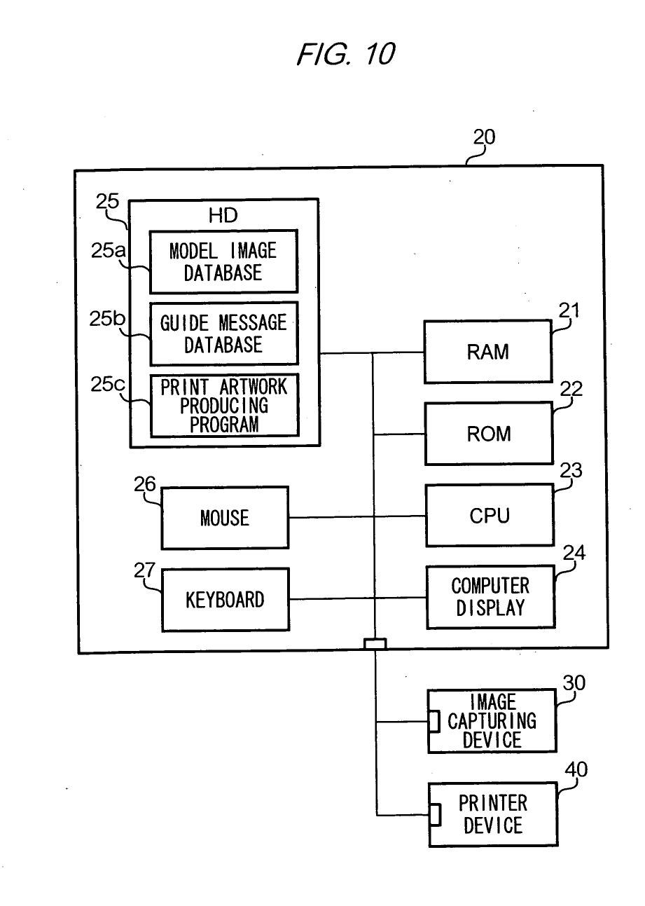

FIG. 10 is a diagram showing an entire configuration of the print artwork producing system according to the present embodiment. As shown in the figure, the system comprises a skill learning terminal 20, an image capturing device 30, and a printer device 40.

Skill learning terminal 20 comprises a RAM 21, a ROM 22, a CPU 23, a computer display 24, a hard disk (HD) 25, a mouse 26, a keyboard 27, and the like. HD 25 stores, in addition to an OS (not shown) software, a model image database 25a, a guide message database 25b, and a print artwork producing program 25c.

The model image database 25a stores model images of paper-etching artworks in correspondence with identifiers for identifying each artwork. A person learning a print technique follows these model images by using the system of the present embodiment so that the aesthetic qualities expressed in the model images can be reproduced using his/her own processing skills.

Guide message database 25b stores guide messages corresponding to different degrees of deviation from the model image data, where the guide messages are prepared in advance.

FIG. 11 is a data configuration of the guide message database 25b. The database 25b has two fields: “score” and “message.” In the “score” field, there is stored a score showing the degree of deviation of the print image data from the model image data; and a guide message is stored in the “message” field. Examples of stored guide messages are as follows: “It is better to peel away another layer of resin of the paper”; “Scorched area is too large”; and “Chipping the paper a little deeper will give a more strongly defined appearance to the line.”

The print artwork producing program 25c is a program for causing CPU 23 to execute an operation particular to the present embodiment. CPU 23 executes the print artwork producing program 25c, and thereby performs the following functions.

a. Image Output Function

By the image output function, a model image created based on model image data and a print image created based on print image data are output.

b. Score Computing Function

By the score computing function, print image data is compared to model image data, and a score is computed based on the degree of deviation between the two data.

c. Message Output Function

By the message output function, a guide message corresponding to the computed score is read and output from the guide message database 25b.

d. Image Cutting Function

By the image cutting function, an image drawn in a particular area of a model image is cut.

e. Image Overwriting Function

By the image overwriting function, an image cut from a model image is overwritten on a print image.

Configurations of image capturing device 30 and printer device 40 are the same as those of the first embodiment.

Description will be now given of an operation of the present embodiment. A learner first selects, as a model artwork to be taken as an example, one of the model images whose data are stored in the model image database 25a, and then prepares a printout of the selected model image. The learner then processes a paper sheet for paper etching, and produces an artwork by copying the model artwork.

When the learner has completed the processing of a paper sheet, s/he activates the print artwork producing program 25c. Operation of the present embodiment is then started.

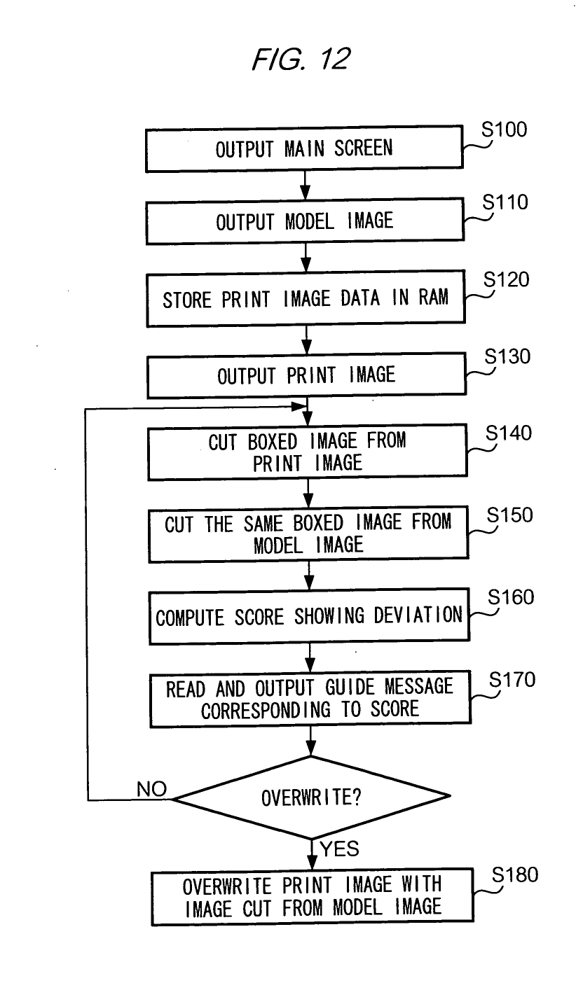

FIG. 12 is a flowchart showing an operation of the present embodiment.

CPU 23 of skill learning terminal 20 generates and outputs data of a main screen for display on computer display 24 (S100).

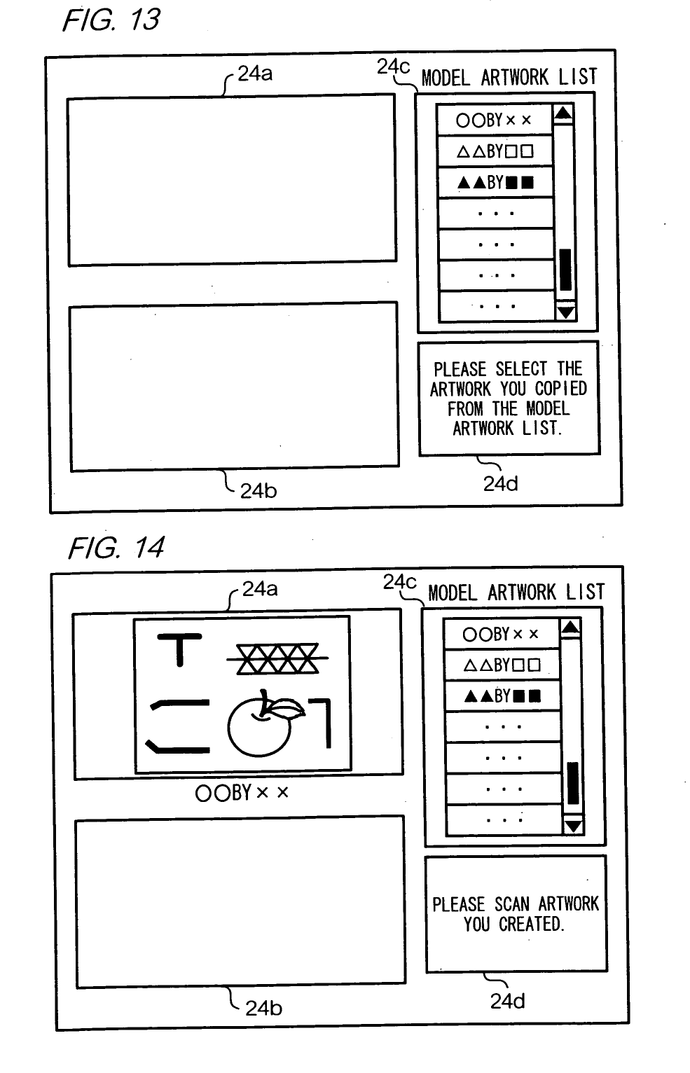

FIG. 13 is a diagram showing an example of a main screen. In the upper left side of the screen, a model image displaying field 24a is provided, and provided below the model image displaying field 24a is a print image displaying field 24b. In the upper right portion of the screen, a model artwork list 24c is displayed. Below the model artwork list 24c is a message displaying field 24d, where a prompt message is displayed, such as “Please select the artwork you copied from the model artwork list.”

The learner selects the copied artwork by moving an icon onto the name of the artwork to be selected from the model artwork list 24c.

CPU 23 of skill learner terminal 20 reads out model image data of the selected artwork from the model image database 24b to RAM 21, and outputs a model image created based on the read model image data to computer display 24 (S110).

FIG. 14 is a diagram showing an example of a main screen where a model image is displayed. In the model image displaying field 24a a model image is shown, and displayed below the model image is the name of the artwork and its artist. Further, displayed in the message displaying field 24d is a message such as “Please scan your own artwork.”

The learner then uses image capturing device 30 to capture light transmitted through a paper sheet on which designs have been formed using the processing techniques. Image capturing device 30 transmits to skill learning terminal 20 paper image data generated by capturing the image of the processed paper sheet.

CPU 23 of skill learning terminal 20 that has obtained the print image data from image capturing device 30 stores the print image data in RAM 21 (S120). A print image created based on the print image data is output to be displayed on computer display 24 (S130).

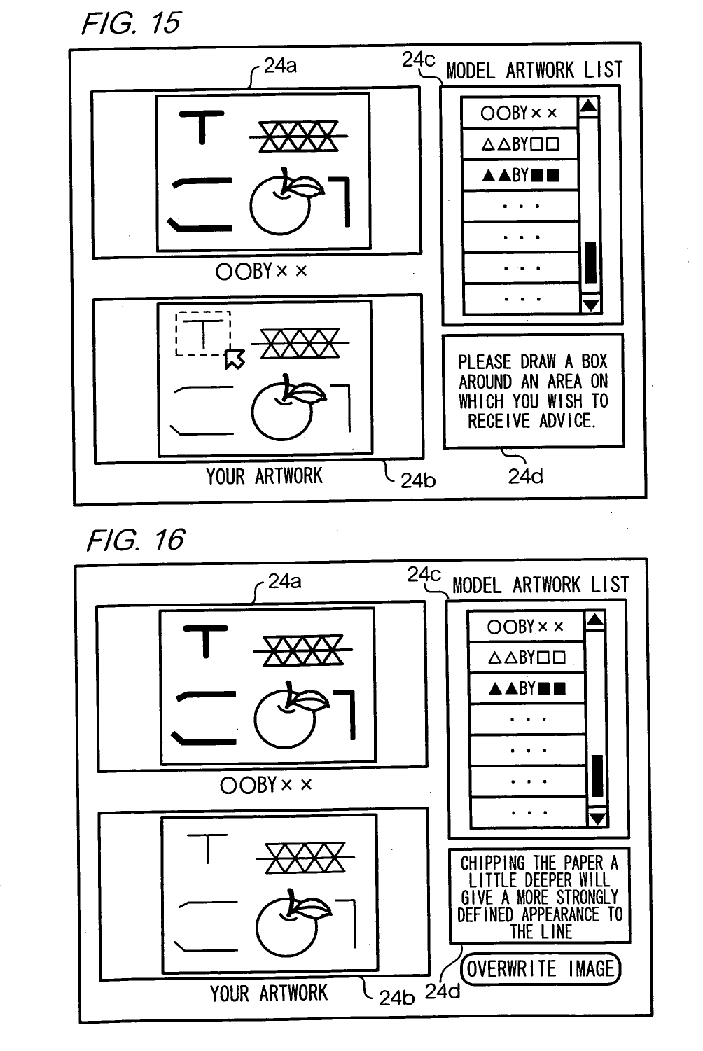

FIG. 15 is a diagram showing an example of a main screen where the print image is shown. In the print image displaying field 24b, a print image is displayed. Further displayed in the message displaying field 24d is a message such as “Please draw a box around an area on which you wish to receive advice.” The learner then moves an icon to a given area in the print image displaying field 24b and performs a drag-and-drop operation, thereby drawing a box around a design on which the learner wishes to receive advice on the quality of his/her own work and for improving his/her artistic skills based on the advice.

When a drag-and-drop operation is performed, CPU 23 cuts, from the print image, an image drawn in the box designated by the operation (S140). Further, the corresponding area of the model image is identified, and an image drawn in the identified area is cut (S150). CPU 23 then compares the two cut images and computes a score showing the degree of deviation between the images (S160). The computation is performed according to a predetermined algorithm for quantifying differences of degree of lightness or chroma between the two images.

CPU 23 reads a guide message corresponding to the computed score from guide message database 25b, for output to computer display 24. (S170).

FIG. 16 is an example of a main screen where a guide message is displayed. Displayed in the message displaying field 24d of the main screen is a guide message such as “Chipping the paper a little deeper will give a more strongly defined appearance to the line.” Such messages help the learner to improve his/her artistic skills. Further displayed below the message displaying field 24d is a button saying “Overwrite image” used for instructing overwriting the boxed area of the print image with the model image corresponding thereto.

When the “Overwrite image” is selected, CPU 23 overwrites the image cut from the model image in Step 140 on the corresponding area of the print image (S180). The learner is then able to visualize how the design in the boxed area can be expressed if the print image is produced in the same way as the model image.

When the learner draws a box around another section of a print image, the above process is repeated.

According to the second embodiment described above, the learner performs an operation of drawing a box around a given area of a print image obtained from a paper sheet which s/he has produced. The learner is then given appropriate advice for improving his/her artistic skills, on the basis of works by famous artists. Thus, the learner can improve his/her own technique without receiving direct guidance from a famous artist.

### C. Third Embodiment

In the second embodiment, processes such as computing a score and outputting a guide message are performed in a local environment. In the third embodiment, a server device assisting the learning of a printing technique is provided in a network, and the server device performs the process of computing a score and outputting a message in response to a request from a remote skill learning terminal.

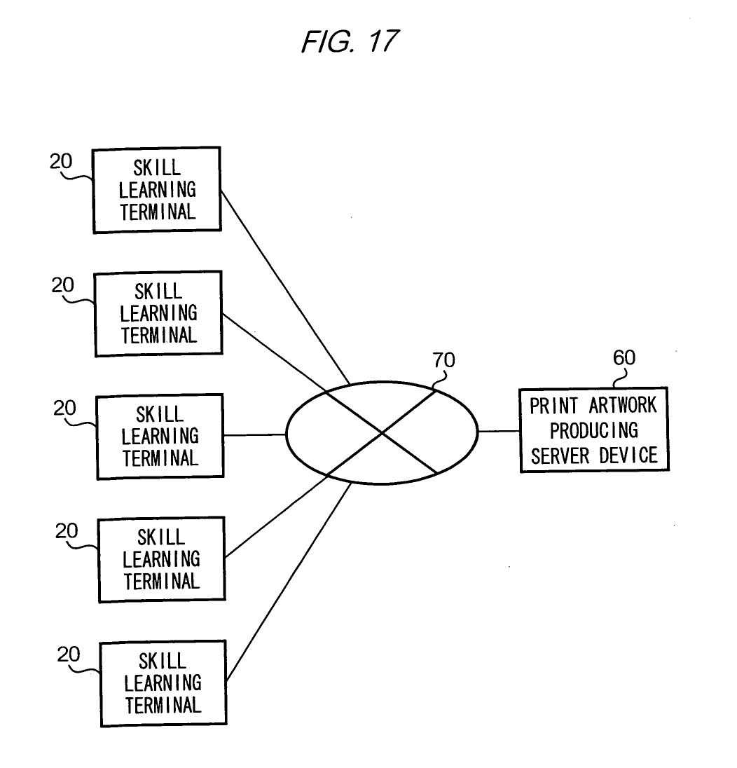

FIG. 17 is a diagram showing an entire configuration of a print artwork producing system according to the third embodiment. The system comprises a print artwork producing server device 60 and a plurality of skill learning terminals 20 connected to a network 70. A hard disk provided in the print artwork producing server device 60 stores a model image database 25a, a guide message database 25b, and a print artwork producing program 25c. Server device 60 further comprises an image output function, a score computing function, a message output function, an image cutting function, and an image overwriting function. When receiving a file containing a print image data from one of the plurality of skill learning terminals 20, server device 60 generates one of the screen data such as that shown in FIG. 13 to FIG. 16 for transmission to the requesting terminal 20.

According to the above described embodiment, each learner can receive appropriate advice for improving his/her own technique by accessing a print artwork producing server and transmitting print image data from his/her own terminal by using a browser.

### D. Modifications

In the foregoing, description has been given of preferred embodiments of the present invention. The present invention is not limited to such embodiments but may be modified in its scope of technical concept.

In the first embodiment, paper having multi-layered fibers is used for paper etching. However, a plastic plate may be used instead of paper. When a plastic plate is used, the peeling processing cannot be applied, but processing such as cutting, scorching, and compressing can be used, as in the case of the paper fibers. As a result, a unique print artwork can be obtained based on the transmitted light that penetrates the plate.

In the second embodiment, model image data of several artworks are stored in the model image database 25a of skill learning terminal 20 in advance, and the learner selects an artwork which s/he copied, to receive advice. A server device provided in a network may act to transmit model image data, from which server device skill learning terminal 20 downloads model image data of a particular artwork.

Further, the above print artwork producing program 25c may be stored in a recording medium such as a CD-ROM (Compact Disk-Read Only Memory), so as to have a general computer device read the program from such a recording medium, thereby imparting the same functions as those of skill learning terminal 20 to the computer device. Also, a server device may be provided in a network to provide this type of program, so that the program may be downloaded to a computer device in response to a request therefrom.

Further, a hardware device having a function of generating a paper-etching artwork may be configured as one unit.

For example, such a hardware device may comprise a storage unit such as an EEPROM (Electrically Erasable and Programmable ROM) or a flash memory, a light source for irradiating light to a back surface of a plate, an image capturing unit for capturing an image light transmitted through the plate and emitted from the front surface of the plate, a generation unit for generating print image data from light captured by the image capturing unit and storing in the storage unit, and a print image output unit for reading and outputting the print image data stored in the storage unit.

Thus, using hardware having only a function of exclusively generating a paper-etching artwork and having no learning function, a learner is able to produce a paper-etching artwork freely based on his/her own inspiration without referring to a model artwork.

1. A print artwork producing method comprising:
obtaining image data defining a design pre-formed on a plate, by irradiating light onto a back surface of said plate and scanning said light transmitted through said plate;
digitally processing said obtained image data; and
printing said digitally processed image data on a paper medium.

2. The method of claim 1, wherein said plate is a sheet of paper consisting of multi-layered fibers.

3. The method of claim 1, wherein said pre-formed design has been formed by at least one of cutting, chipping, peeling, scorching, and compressing.

4. The method of claim 1, wherein said digital processing step includes changing tones of color of said image data obtained in said scanning step.

5. The method of claim 1, wherein said digital processing step includes overlaying new image data onto said image data obtained in said obtaining step.

6. A print artwork producing device comprising:
a storage unit;
a light source for irradiating light to a back surface of a plate;
an image capturing unit for capturing said light transmitted through said plate and emitted from a front surface of said plate;
a generation unit for generating print image data from said light captured by said imaging unit, for storage into said storage unit; and
a print image output unit for reading and outputting said print image data stored in said storage unit.

7. A print artwork producing device comprising:
a light source for applying light onto a back surface of a plate;
an image capturing unit for capturing said light transmitted through said plate and emitted from a front surface of said plate;
a generation unit for generating print image data from said light captured by said image capturing unit;
a storage unit for storing model image data showing a model print artwork, and for storing data of a guide message providing information for correcting processing techniques of said plate, said guide message being stored in correspondence with score data showing deviation of said print image data from said model image data;
a computing unit for comparing said print image data to said model image data and obtaining a score showing deviation of said print image data from said model image data; and
an output device for reading from said storage unit and outputting a guide message corresponding to said computed score.

8. A print artwork producing device comprising:
an input unit for inputting print image data received as a result of light being applied to a plate;
a storage unit for storing model image data showing a model print artwork, and storing data of a guide message providing information for correcting deviation of said print image data from said model image data, said guide message being stored in correspondence with score data showing said deviation;
a computing unit for comparing said print image data input from said input unit to said model image data and obtaining a score showing deviation of said print image data from said model image data; and
an output unit for reading from said storage unit and outputting a guide message corresponding to said computed score.

9. The device of claim 7, further comprising:
image output means for outputting a model image created based on said model image data and a print image created based on said print image data;
image cutting means for cutting an image drawn in a particular area of said model image; and
image overwriting means for overwriting the cut image on said print image.

10. A program product for causing a computer to execute processes,
said computer having:
a light source for applying light onto a back surface of a plate;
an image capturing unit for capturing said light transmitted through said plate and emitted from a front surface of said plate, so as to obtain print image data;
a storage unit for storing model image data showing a model print artwork, and storing data of a guide message providing information for correcting processing techniques of said plate, said guide message being stored in correspondence with score data showing deviation of said print image data from said model image data, and
said processes comprising:
a process of generating said print image data from said light captured by said image capturing unit;
a process of comparing said generated print image data to said model image data and obtaining a score showing deviation of said print image data from said model image data; and
a process of reading from said storage unit and outputting a guide message corresponding to said computed score.

11. A program product for causing a computer to execute processes,
said computer having:
an input unit for inputting print image data received as a result of light being applied to a plate;
a storage unit for storing model image data showing a model print artwork, and storing data of a guide message providing information for correcting deviation of said print image data from said model image data, said guide message being stored in correspondence with score data showing said deviation, and
said processes comprising:
a process of comparing said print image data input from said input unit to said model image data and obtaining a score showing deviation between said print image data and said model image data; and
a process of reading from said storage unit and outputting a guide message corresponding to said computed score.

12. The program product of claim 10, comprising:
having said computer further execute:
a process of outputting a model image created based on said model image data and a print image created based on said print image data;
a process of cutting an image drawn in a particular area of said model image; and
a process of overwriting the cut image on said print image.

13. The device of claim 8, further comprising:
image output means for outputting a model image created based on said model image data and a print image created based on said print image data;
image cutting means for cutting an image drawn in a particular area of said model image; and
image overwriting means for overwriting the cut image on said print image.

14. The program product of claim 11, comprising:
having said computer further execute:
a process of outputting a model image created based on said model image data and a print image created based on said print image data;
a process of cutting an image drawn in a particular area of said model image; and
a process of overwriting the cut image on said print image.
